(19) United States
(12) Patent Application Publication
(10) Pub. No.: US 2012/0182309 A1
(43) Pub. Date: Jul. 19, 2012

(54) DEVICE AND METHOD OF CONVEYING EMOTION IN A MESSAGING APPLICATION

(75) Inventors: Jason Tyler Griffin, Waterloo (CA); Steven Henry Fyke, Waterloo (CA)

(73) Assignee: RESEARCH IN MOTION LIMITED, Waterloo (CA)

(21) Appl. No.: 13/007,285

(22) Filed: Jan. 14, 2011

(51) Int. Cl. G09G 5/00; G06F 3/041; H04W 4/00

(52) U.S. Cl. 345/619; 455/466; 345/173

(57) ABSTRACT

The present disclosure provides a device and method to convey emotions in a messaging application of a mobile electronic device. An emotional context of text entered into the messaging application is determined and an implied emotional text is presented for at least a portion of the entered text in accordance with the determined emotional context. The emotional context may be determined from captured sensor data captured by one or more sensors.

### CROSS REFERENCE TO RELATED APPLICATIONS

This application is related to co-pending U.S. patent applications: application Ser. No. ______, Attorney Docket Number 37012-1-US-PAT, filed on even date herewith, which is incorporated herein in its entirety.

### TECHNICAL FIELD

The present disclosure relates generally to mobile electronic devices, and more particularly to a method and device for conveying emotion in a messaging application.

### BACKGROUND

There is a desire to communicate emotions, such as playfulness, fear, aggression, happiness, etc., through text communication. Quick messaging applications that run on mobile electronic devices typically rely on the use of emoticons to communicate emotion associated with text entered in the messaging application. Emoticons commonly refer to a pictorial representation of a facial expression represented by punctuation and letters that conveys a writer's mood, emotion, or tenor of the plain or base text that it accompanies. Examples of emoticons include a smiley face, a frowning face, happy face, etc.

A user of a messaging application chooses a desired emoticon from a list or grid of available, predefined and stored, emoticons. While the availability of emoticons provides a way of expressing a writer's mood or temperament with regard to entered text, the use of emoticons detracts from the fluidity and spontaneity of the communication. Separate from text entry, a user must scroll through a list or grid of available emoticons, to choose a desired font style, facial expression, animation, etc. Moreover, the desired emotion to be conveyed may not be available from the predefined set of available emoticons. The process for choosing one or more emoticons, then, to indicate emotion associated with entered text necessarily interrupts drafting and sending a message in the messaging application.

Improvements in messaging applications of mobile electronic devices are desirable.

### BRIEF DESCRIPTION OF THE DRAWINGS

Example embodiments of the present disclosure will be described below with reference to the included drawings such that like reference numerals refer to like elements and in which:

FIGS. 1A-1C are illustrations of a quick messaging application employing implied emotional text on a touch screen display of a mobile electronic device, in accordance with various embodiments of the present disclosure;

FIG. 2 is an illustration of a quick messaging application employing implied emotional text on a display of a mobile electronic device, in accordance with various embodiments of the present disclosure;

FIG. 3 is an illustration of a mobile electronic device in accordance with various embodiments of the present disclosure;

FIG. 4 is a block diagram representation of the mobile electronic device of FIG. 4 in accordance with various embodiments of the present disclosure;

FIGS. 5A-5B is an illustration of a mobile electronic device that employs a virtual keypad mode and a touch-sensitive input surface, in accordance with various additional embodiments of the present disclosure;

FIG. 6 is a block diagram representation of the mobile electronic device of FIGS. 5A-5B in accordance with the various additional embodiments of the present disclosure;

FIG. 7 is an illustration of a motion detection subsystem in accordance with various embodiments of the present disclosure;

FIG. 8 is an illustration of a network system including first and second mobile electronic devices, in accordance with an example embodiment of the present disclosure;

FIG. 9-13 are flow charts of various methods for conveying emotion in a messaging application executed on a mobile electronic device, in accordance with various embodiments of the present disclosure;

### DETAILED DESCRIPTION

There is a desire to communicate emotions, such as playfulness, fear, aggression, happiness, etc., through text communication. The use and usefulness of emoticons are limited and do not provide the level of expressiveness and fluidity of emotion provided by the various embodiments described herein. It is desirable to have a more expressive and fluid communication of emotion associated with text in a messaging application. The various embodiments described herein provide a fluid, intuitive, easy and fun way to communicate text emotion.

The disclosure generally relates to conveying emotion in a messaging application of a mobile electronic device, and the following describes a method and device for conveying emotion in a messaging application. The method and device of the present disclosure allows emotions to be smoothly conveyed as an implied emotional text within a messaging application run by a mobile device, such as a mobile messaging platform like quick messaging application BlackBerry Messenger from Research In Motion of Waterloo, Canada or the like. Sensor input data are analyzed in order to determine the implied emotional text of text entered into a messaging application of the mobile device. Biometric sensors such as pressure sensors, accelerometers, video sensors, Galvanic skin response sensors, may be used to capture biometric data of a user of the mobile device, including blood pressure, heart rate, muscle control, shaking, facial expressions, Galvanic skin response, etc. that may be useful in determining the emotional state of the user. In combination with such biometric sensors or alternately, sensors such as accelerometers, tilt sensors, movement sensors, magnetometers, gyroscopes, or the like, may be used to collect usage data about usage of the mobile device to again determine an implied emotional context of text entered into a messaging application of the mobile device. The emotional context of entered text may be determined while in a text entry mode of the mobile device, such as while a user is entering the text, or it may be determined after the text has been entered. As will be seen, the determined implied emotional text may be presented by a display element of the mobile device or by a display element of a remote device, mobile or not, with which the mobile device is in communication. The implied emotional text may have one or more components, including a font style component, an animation component, and a color component, associated with the determined emotional context of the entered text. In this way, emotions such as humor, fear, anger, happiness, love, surprise, and others may be easily and readily communicated in a messaging application format.

In accordance with an embodiment of the present disclosure, there is provided a method of conveying emotion in a messaging application is presented, the method comprising: determining an emotional context of text entered in the messaging application of a mobile device; changing the manner in which at least a portion of the text is presented from a base text in which text is normally presented in a text entry mode of the mobile device to an implied emotional text in accordance with the determined emotional context of the text; and presenting the implied emotional text for at least the portion of the text entered in a display element. In accordance with various embodiments, determining the emotional context may further comprise: determining whether a current emotional state associated with the at least a portion of text entered in the messaging application of the mobile device is different from a previous emotional state of text entered in the messaging application; and presenting the at least the portion of text as modified text with an emotional context determined by the difference between the current emotional state and the previous emotional state when the difference between the current emotional state and the previous emotional state is not within a normal emotional range.

In accordance with another embodiment of the present disclosure, there is provided a method of conveying emotion in a messaging application, comprising: determining an emotional context of text entered in the messaging application of a mobile device; and presenting in the messaging application an implied emotional text for at least a portion of the text entered in the messaging application in accordance with the determined emotional context, wherein the implied emotional text for the at least the portion of the text is different from a base text in which text is presented in the messaging application of the mobile device.

In accordance with a further embodiment of the present disclosure, there is provided a mobile device, comprising: a processor for controlling operation of the mobile device; a sensor detection element coupled to the processor and configured to capture data representative of an emotional context of text entered in a messaging application of the mobile device; the processor being configured to determine the emotional context from the captured data and to change the manner in which at least a portion of the text is normally presented in a text entry mode of the mobile device to an implied emotional text in accordance with the determined emotional context of the text.

In accordance with other embodiments of the present disclosure, there is provided a method of conveying emotion in a messaging application, comprising: capturing sensor data; determining an emotional state associated with text entered in the messaging application of a mobile device by analyzing the captured sensor data; mapping the determined emotional state to an implied emotional text; and presenting in the messaging application the implied emotional text for at least a portion of the text entered in accordance with the determined emotional state.

In accordance with a still further embodiment of the present disclosure, there is provided a method of conveying emotion in a messaging application, comprising: capturing accelerometer, data of a mobile device; determining an emotional state associated with the captured accelerometer data by analyzing the captured accelerometer data; mapping the determined emotional state associated with the captured accelerometer data to an implied emotional text; and presenting the implied emotional text for at least a selected portion of text entered in the messaging application in accordance with the determined emotional state.

In accordance with another embodiment of the present disclosure, there is provided a mobile device, comprising: a processor for controlling operation of the mobile device; a sensor detection element coupled to the processor and configured to capture data associated with text entered in a messaging application of the mobile device; and a display element coupled to and under control of the processor; the processor being configured to determine an emotional state associated with the entered text by analyzing the captured sensor data, to map the determined emotional state to an implied emotional text, and to present in the messaging application via the display element the implied emotional text for at least a portion of the text entered in accordance with the determined emotional state.

In accordance with further embodiments of the present disclosure, there is provided a computer program product comprising a computer readable medium storing instructions in the form of executable program code for causing the mobile electronic device to perform the described methods.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

As used herein, a mobile electronic device, sometimes referred to as a handheld electronic device or simply an electronic device, is a two-way communication device having at least data and possibly also voice communication capabilities, and the capability to communicate with other mobile devices or computer systems, for example, via the Internet. Depending on the functionality provided by the mobile electronic device, in the various embodiments described herein, the device may be a data communication device, a multiple-mode communication device configured for both data and voice communication, a smartphone, a mobile telephone or a personal digital assistant PDA (personal digital assistant) enabled for wireless communication, or a computer system with a wireless modem. Other examples of mobile electronic devices include mobile, or handheld, wireless communication devices such as pagers, cellular phones, cellular smart-phones, wireless organizers, wirelessly enabled notebook computers, and so forth. The mobile electronic device may also be a portable electronic device without wireless communication capabilities, such as a handheld electronic game device, digital photograph album, digital camera, or other device.

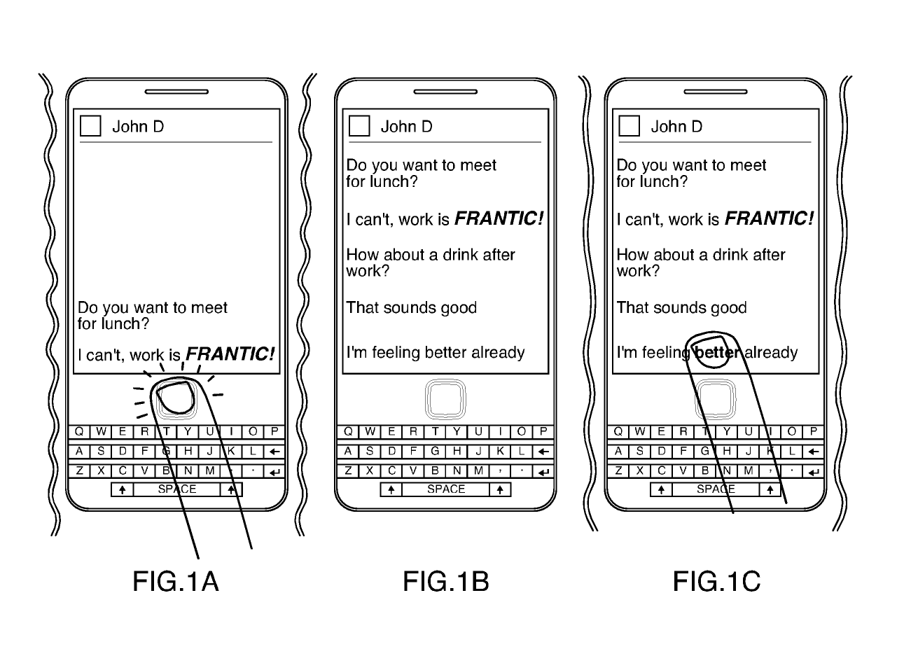

Referring now to FIGS. 1A-1C, three screen shots of a touch-screen display and interface of a mobile device are shown. In FIG. 1A, it can be seen that a user has entered the following text “I can't, work is frantic” in a messaging application in response to the question, “Do you want to meet for lunch?” From the display screen, it can be seen that the word “frantic!” clearly communicates that the writer is indeed frantic; the letters of the word are all capitalized, larger and may be in a color that denotes a frantic state, such as red. The word frantic! is an implied emotional text implied from data received by one or more sensors of the mobile electronic device and analyzed to determine an emotional context, as will be described. The collected data may be biometric data, such as pulse, blood pressure, skin response, that provides involuntary biometric information about the mood or emotion of the user of the mobile device or the captured data may be usage data that provides usage information about how the user is using the mobile device. Some combination of these two may be used if so desired. In the case of biometric data that represents involuntary, physiological data about the user, the collection of such data is clearly transparent to the user and certainly adds to the fluidity of the quick messaging experience.

Consider the following example, in which the implied emotional text is determined from analyzed usage data. In FIG. 1A, the user is shown holding down a trackpad after typing “frantic!” and then shaking the mobile device in a sharp aggressive manner. This aggressive usage of the mobile device is indicated by the jagged vertical lines marked as “FRANTIC MOTION” on either side of the mobile device in FIG. 1A. This usage data (shaking the mobile device sharply and aggressive) is captured by one or more sensors of the mobile device, such as an accelerometer, and analyzed by a processor of the mobile device to generate the implied emotional text: all caps, red in color (for example), in italics, and a more aggressive font. It can be seen that the implied emotional text of frantic! is quite different from the base text “I can't, work is” In this example, the implied emotional text has a font style component (an aggressive font) and a color component (red) that is quite different from the base text in the messaging application. While it can't be seen in the drawing, the implied emotional text may additionally include an animation component, such as the word FRANTIC! moving, well, frantically!

In the next drawing of FIG. 1B, the user has typed a message reading, “I'm feeling better already”, which is shown in the base text of the messaging application. In FIG. 1C, the user goes back and selects the word “better” by touching it on the touch-screen and then moves the device in a gentle back and forth motion. This gentle usage of the mobile device is indicated by the smooth, wavy vertical lines on either side of the mobile device marked as “GENTLE MOTION”; this gentle motion is quite different from the frantic motion of the mobile device in FIG. 1A. This has the effect of changing the font of the word “better” from a base font to an implied emotional text having a softer font and a more soothing font color, such as a soft blue rather than the harsher black font color. The implied emotional text representation of “better” has a font style component and a color component as shown.

Collection of data, usage or biometric or both, may commence in response to a trigger event, or it may be that sensor data is always collected in a text entry mode or otherwise; such might be the case, for example, in capturing biometric data that does not require an affirmative action or decision of the user to commence its collection. A trigger event may be entry into a text mode entry of the mobile device, detecting the user of the mobile device activating a navigation element of the mobile device to select a portion of entered text. The navigation element may be an optional joystick (OJ) of the mobile device, a trackball of the mobile device, a touch screen of the mobile device, etc.

In the example above, the selection of a portion of the text (“frantic!” in FIG. 1A and “better” in FIG. 1C) by the user may acts as a trigger event for the sensors of the mobile device to capture the usage data from which the implied emotional text is determined. Or, a trigger event may not be required. Usage data may always be captured during operation of the mobile device or when in the text entry mode of the mobile device.

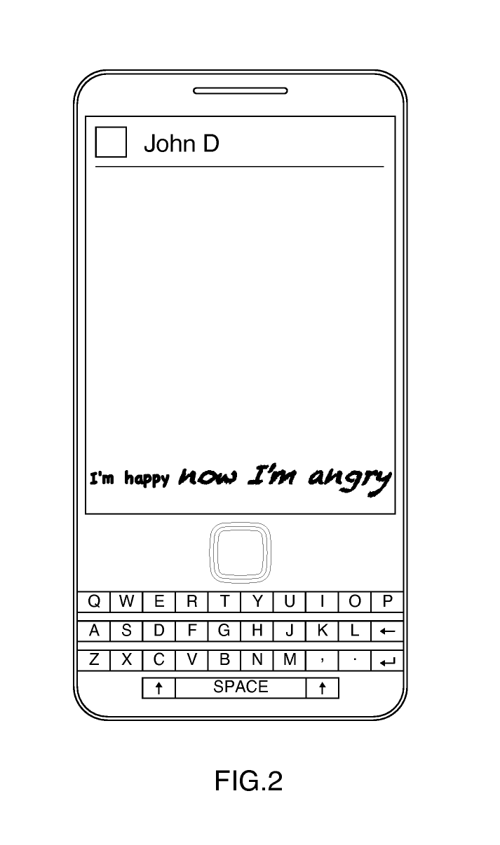

FIG. 2 provides an exemplary embodiment in which the transition from a first to a second implied emotional text is accomplished seamlessly without involvement of the user, based upon capturing and analyzing collected biometric data of the user. Implied emotional text 1 for “I'm happy” shows a gentler, happier font (such as pink or yellow) and perhaps font color than the implied emotional text 2 for “now I'm angry”, which conveys an angry, more aggressive emotion through the use of an angry font, larger size, and perhaps font color, as well (red, perhaps).

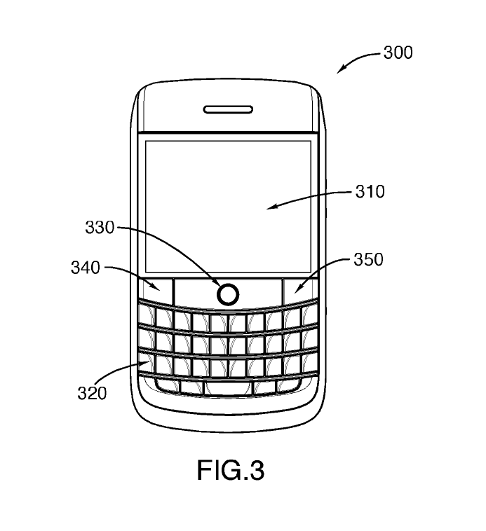

FIG. 3 is an illustration of a mobile electronic device 300 in accordance with various embodiments disclosed herein. Mobile electronic device 300 has a screen 310 for displaying information, a keyboard 320 for entering information such as composing e-mail messages, and a pointing device 330 such as a trackball, trackwheel, touchpad, and the like, for navigating through items on screen 310. In this example embodiment, device 300 also has a button 340 for initiating a phone application (not shown), and a button 350 for terminating phone calls.

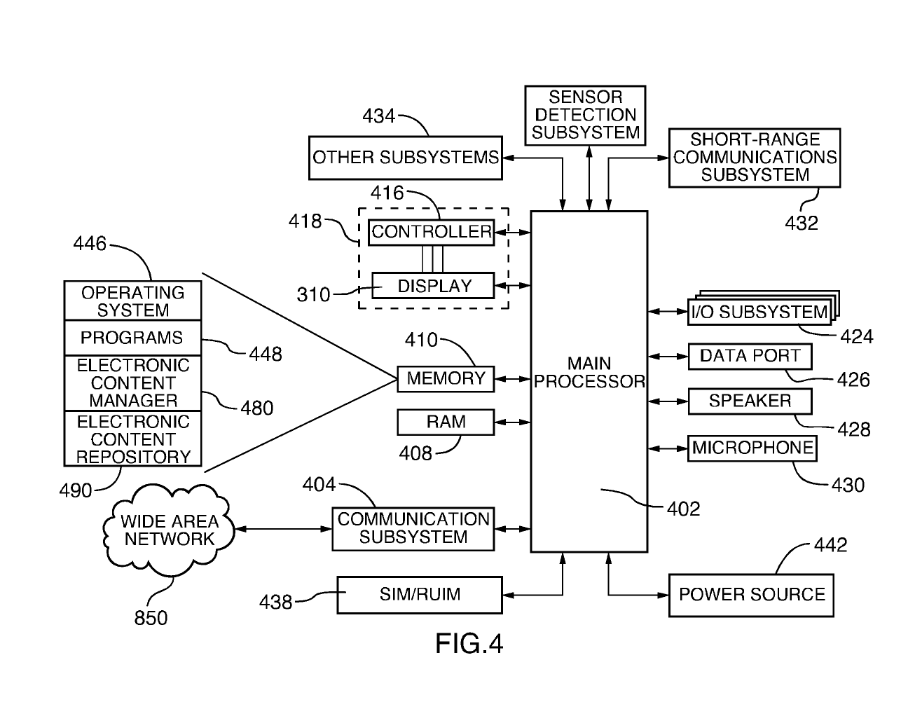

FIG. 4 is a block diagram of an example functional representation of the mobile electronic device 300 of FIG. 3 in accordance with various embodiments disclosed herein. Mobile electronic device 300 includes multiple components, such as a processor 402 that controls the overall operation of mobile electronic device 300. Communication functions, including data and voice communications, are performed through a communication subsystem 404. Communication subsystem 404 receives data from and sends data to a wireless wide area network 850 in long-range communication. An example of the data sent or received by the communication subsystem includes but is not limited to e-mail messages, short messaging system (SMS), web content, and electronic content. The wireless network 850 is, for example, a cellular network. In some example embodiments, network 850 is a WiMax™ network, a wireless local area network (WLAN) connected to the Internet, or any other suitable communications network. In other example embodiments, other wireless networks are contemplated, including, but not limited to, data wireless networks, voice wireless networks, and networks that support both voice and data communications.

A power source 442, such as one or more rechargeable batteries, a port to an external power supply, a fuel cell, or a solar cell powers mobile electronic device 300.

The processor 402 interacts with other functional components, such as Random Access Memory (RAM) 408, memory 410, a display screen 310 (such as, for example, a LCD) which is operatively connected to an electronic controller 416 so that together they comprise a display subsystem 418, an input/output (I/O) subsystem 424, a data port 426, a speaker 428, a microphone 430, short-range communications subsystem 432, sensor detection subsystem 460, and other subsystems 434. It will be appreciated that the electronic controller 416 of the display subsystem 418 need not be physically integrated with the display screen 310.

The auxiliary I/O subsystems 424 could include input devices such as one or more control keys, a keyboard or keypad, navigational tool (input device), or both. The navigational tool could be a clickable/depressible trackball or scroll wheel, or touchpad. User-interaction with a graphical user interface is performed through the I/O subsystem 424.

Mobile electronic device 300 also includes one or more clocks including a system clock (not shown) and sleep clock (not shown). In other embodiments, a single clock operates as both system clock and sleep clock. The sleep clock is a lower power, lower frequency clock.

To identify a subscriber for network access, mobile electronic device 300 uses a Subscriber Identity Module or a Removable User Identity Module (SIM/RUIM) card 438 for communication with a network, such as the wireless network 850. Alternatively, user identification information is programmed into memory 410.

Mobile electronic device 300 includes an operating system 446 and software programs, subroutines or components 448 that are executed by the processor 402 and are typically stored in a persistent, updatable store such as the memory 410. In some example embodiments, software programs 448 include, for example, personal information management applications, communications applications, messaging applications, games, and the like.

An electronic content manager 480 is included in memory 410 of device 300. Electronic content manager 480 enables device 300 to fetch, download, send, receive, and display electronic content as will be described in detail below.

An electronic content repository 490 is also included in memory 410 of device 300. The electronic content repository or database, 490 stores electronic content such as electronic books, videos, music, multimedia, photos, and the like.

Additional applications or programs are be loaded onto mobile electronic device 300 through data port 426, for example. In some embodiments, programs are loaded over the wireless network 850, the auxiliary I/O subsystem 424, the short-range communications subsystem 432, or any other suitable subsystem 434.

As will be described further herein, sensor detection subsystem 460 may include sensors able to detect a current emotional state associated with text entered into a messaging application being executed by the mobile electronic device 300. The emotional state may be determined by a detected emotional state of a user of the mobile device, in which case the sensors may be biometric sensors of the type able to detect various physiological information about a user, such as blood pressure sensors, heart rate sensors, accelerometer sensors (which may capture shaking, tremors, or other movements, for example), video sensors operable to capture facial expressions of a user, and Galvanic skin response sensors. Biometric data collected by such biometric sensors may be considered to be involuntary, automatic, and not within the purview of the user to control. The emotional state may also be determined by usage of the mobile electronic device and may further be under the direct control of the user. Sensors capable of capturing usage data include motion sensors or subsystems such as accelerometers and movement sensors, gyroscopes, tilt sensors, and magnetometers. It is understood that sensors used for collecting biometric or usage information may be used in any desired configuration, including singly or in combination, and all such configurations are envisioned when referring to sensor detection subsystem 460.

The embodiments disclosed herein may additionally be implemented by one or more mobile electronic devices that employ a virtual keypad mode and a touch-sensitive input surface, as discussed in connection with FIGS. 1A-1C, for example. The present disclosure describes a mobile electronic device having a touch-screen and a method of using a touch-screen of a handheld electronic device. The handheld electronic device may have one or more both of a keyboard mode and an input verification mode, and may be operable to switch between these modes, for example, based on a respective device setting or user input. In the keyboard mode, a keyboard user interface element is presented on the touch-screen (referred to as a virtual keyboard). The touch-screen is used to receive touch inputs resulting from the application of a strike force to input surface of the touch-screen.

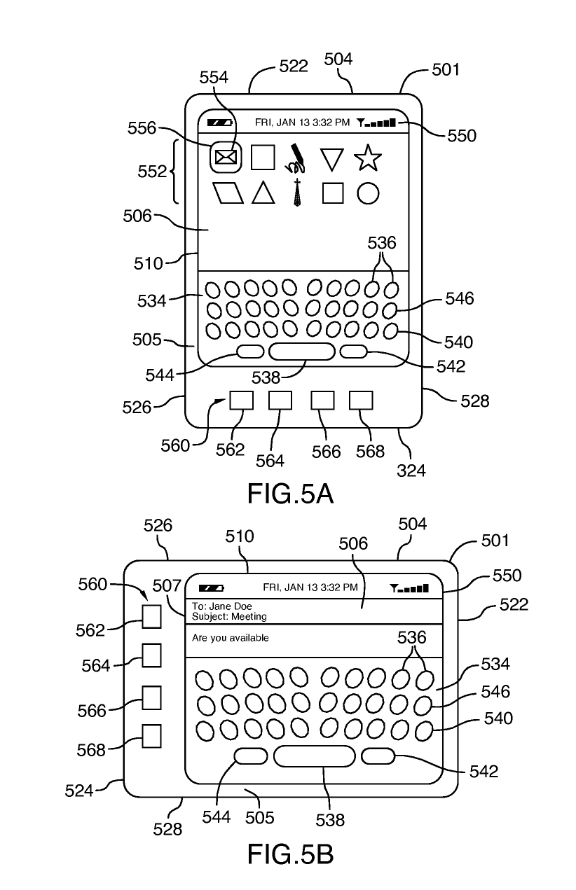

Referring now to FIGS. 5A and 5B, mobile electronic device 502 includes a rigid case 504 for housing the components of the mobile electronic device 502 that is configured to be held in a user's hand while the mobile electronic device 502 is in use. The case 504 has opposed top and bottom ends designated by references 522, 524 respectively, and left and right sides designated by references 526, 528 respectively which extend transverse to the top and bottom ends 522, 524. In the shown embodiments of FIGS. 5A and 5B, the case 504 (and device 502) is elongate having a length defined between the top and bottom ends 522, 524 longer than a width defined between the left and right sides 526, 528. Other device dimensions are also possible.

The mobile electronic device 502 comprises a touch-screen display 506 mounted within a front face 505 of the case 504, a motion detection subsystem 649 having a sensing element for detecting motion and/or orientation of the mobile electronic device 502. The touch-sensitive display 506 may be any suitable touch-sensitive display, such as a capacitive, resistive, infrared, surface acoustic wave (SAW) touch-sensitive display, strain gauge, optical imaging, dispersive signal technology, acoustic pulse recognition, and so forth, as known in the art. A capacitive touch-sensitive display may include a capacitive touch-sensitive overlay. The overlay may be an assembly of multiple layers in a stack including, for example, a substrate, a ground shield layer, a barrier layer, one or more capacitive touch sensor layers separated by a substrate or other barrier, and a cover. The capacitive touch sensor layers may be any suitable material, such as patterned indium tin oxide (ITO).

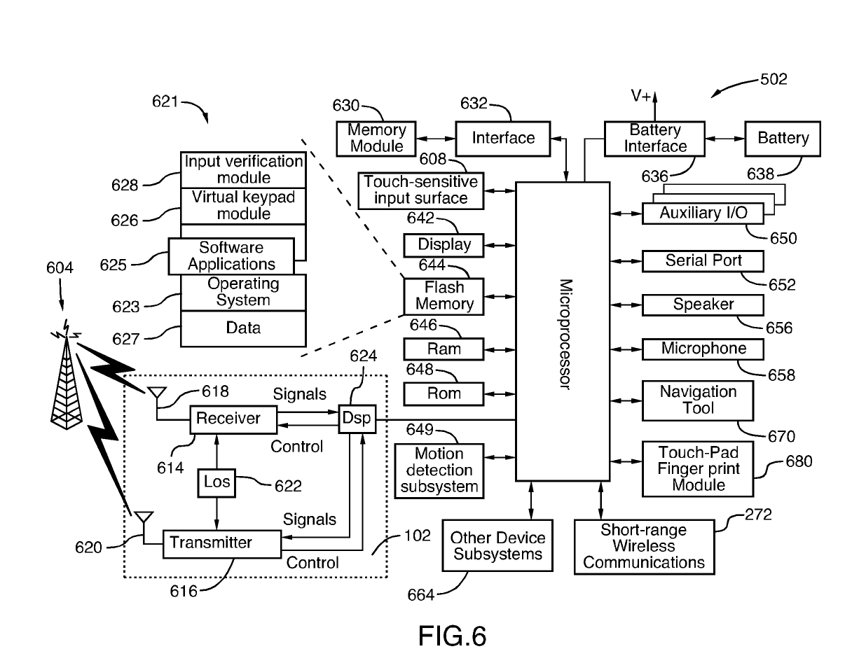

The motion detection subsystem 649 is used when the device 502 is in a keyboard mode, input verification mode, calibration mode or other modes utilizing input from a motion sensor. Additionally, as described herein, the motion detection system may be used for detecting motion of the device 502 in order to determine an emotional context of text entered into a messaging application run by the mobile device 502. Moreover, other types of sensor detection subsystems 680 of FIG. 6 may be employed for determining an emotional context of text. Although the case 504 is shown as a single unit it could, among other possible configurations, include two or more case members hinged together (such as a flip-phone configuration or a clam shell-style lap top computer, for example), or could be a “slider phone” in which the keyboard is located in a first body which is slide-ably connected to a second body which houses the display screen, the device being configured so that the first body which houses the keyboard can be slide out from the second body for use.

The touch-screen display 506 includes a touch-sensitive input surface 508 overlying a display device 642 of FIG. 6 such as a liquid crystal display (LCD) screen. The touch-screen display 506 could be configured to detect the location and possibly pressure of one or more objects at the same time. In some embodiments, the touch-screen display 506 comprises a capacitive touch-screen or resistive touch-screen known in the art.

Referring now to the block diagram 600 of FIG. 6, it can be seen that communication subsystem 611 includes a receiver 614, a transmitter 616, and associated components, such as one or more antenna elements 618 and 620, local oscillators (LOs) 622, and a processing module such as a digital signal processor (DSP) 624. The antenna elements 618 and 621 may be embedded or internal to the mobile electronic device 502 and a single antenna may be shared by both receiver and transmitter, as is known in the art. As will be apparent to those skilled in the field of communication, the particular design of the communication subsystem 621 depends on the wireless network 604 in which mobile electronic device 502 is intended to operate.

The mobile electronic device 502 may communicate with any one of a plurality of fixed transceiver base stations (not shown) of the wireless network 604 within its geographic coverage area. The mobile electronic device 502 may send and receive communication signals over the wireless network 604 after the required network registration or activation procedures have been completed. Signals received by the antenna 618 through the wireless network 604 are input to the receiver 614, which may perform such common receiver functions as signal amplification, frequency down conversion, filtering, channel selection, etc., as well as analog-to-digital conversion (ADC). The ADC of a received signal allows more complex communication functions such as demodulation and decoding to be performed in the DSP 624. In a similar manner, signals to be transmitted are processed, including modulation and encoding, for example, by the DSP 624. These DSP-processed signals are input to the transmitter 616 for digital-to-analog conversion (DAC), frequency up conversion, filtering, amplification, and transmission to the wireless network 604 via the antenna 620. The DSP 624 not only processes communication signals, but may also provide for receiver and transmitter control. For example, the gains applied to communication signals in the receiver 614 and the transmitter 616 may be adaptively controlled through automatic gain control algorithms implemented in the DSP 624.

It will be appreciated that a multiple of possible wireless network configurations for use with the mobile electronic device 502 may be employed. The different types of wireless networks 604 that may be implemented include, for example, data-centric wireless networks, voice-centric wireless networks, and dual-mode networks that can support both voice and data communications over the same physical base stations. New standards are still being defined, but it is believed that they will have similarities to the network behaviour described herein, and it will also be understood by persons skilled in the art that the embodiments described herein are intended to use any other suitable standards that are developed in the future.

The mobile electronic device 502 includes a processor 640 which controls the overall operation of the mobile electronic device 502. The processor 640 interacts with communication subsystem 611 which performs communication functions. The processor 640 interacts with device subsystems such as the touch-sensitive input surface 508, display device 642 such as a liquid crystal display (LCD) screen, flash memory 644, random access memory (RAM) 646, read only memory (ROM) 648, auxiliary input/output (I/O) subsystems 650, data port 652 such as serial data port (for example, a Universal Serial Bus (USB) data port), speaker 656, microphone 658, navigation tool 570 such as a scroll wheel (thumbwheel) or trackball, short-range communication subsystem 662, and other device subsystems generally designated as 664. Some of the subsystems shown in FIG. 6 perform communication-related functions, whereas other subsystems may provide “resident” or on-device functions.

The processor 640 operates under stored program control and executes software modules 621 stored in memory such as persistent memory, for example, in the flash memory 644. The software modules 600 comprise operating system software 623, software applications 625, a virtual keyboard module 626, and an input verification module 628. Those skilled in the art will appreciate that the software modules 621 or parts thereof may be temporarily loaded into volatile memory such as the RAM 646. The RAM 646 is used for storing runtime data variables and other types of data or information, as will be apparent to those skilled in the art. Although specific functions are described for various types of memory, this is merely an example, and those skilled in the art will appreciate that a different assignment of functions to types of memory could also be used.

The software applications 625 may include a range of applications, including, for example, an address book application, a messaging application, a calendar application, and/or a notepad application. In some embodiments, the software applications 625 includes one or more of a Web browser application (i.e., for a Web-enabled mobile communication device), an email message application, a push content viewing application, a voice communication (i.e. telephony) application, a map application, and a media player application. Each of the software applications 625 may include layout information defining the placement of particular fields and graphic elements (e.g. text fields, input fields, icons, etc.) in the user interface (i.e. the display device 642) according to the application.

In some embodiments, the auxiliary input/output (I/O) subsystems 650 may comprise an external communication link or interface, for example, an Ethernet connection. The mobile electronic device 502 may comprise other wireless communication interfaces for communicating with other types of wireless networks, for example, a wireless network such as an orthogonal frequency division multiplexed (OFDM) network or a GPS transceiver for communicating with a GPS satellite network (not shown). The auxiliary I/O subsystems 650 may comprise a vibrator for providing vibratory notifications in response to various events on the mobile electronic device 502 such as receipt of an electronic communication or incoming phone call.

In some embodiments, the mobile electronic device 502 also includes a removable memory card 630 (typically comprising flash memory) and a memory card interface 632. Network access typically associated with a subscriber or user of the mobile electronic device 502 via the memory card 630, which may be a Subscriber Identity Module (SIM) card for use in a GSM network or other type of memory card for use in the relevant wireless network type. The memory card 630 is inserted in or connected to the memory card interface 632 of the mobile electronic device 502 in order to operate in conjunction with the wireless network 604.

The mobile electronic device 502 stores data 627 in an erasable persistent memory, which in one example embodiment is the flash memory 644. In various embodiments, the data 627 includes service data comprising information required by the mobile electronic device 502 to establish and maintain communication with the wireless network 604. The data 627 may also include user application data such as email messages, address book and contact information, calendar and schedule information, notepad documents, image files, and other commonly stored user information stored on the mobile electronic device 502 by its user, and other data. The data 627 stored in the persistent memory (e.g. flash memory 644) of the mobile electronic device 502 may be organized, at least partially, into a number of databases each containing data items of the same data type or associated with the same application. For example, email messages, contact records, and task items may be stored in individual databases within the device memory.

The serial data port 652 may be used for synchronization with a user's host computer system (not shown). The serial data port 652 enables a user to set preferences through an external device or software application and extends the capabilities of the mobile electronic device 502 by providing for information or software downloads to the mobile electronic device 502 other than through the wireless network 604. The alternate download path may, for example, be used to load an encryption key onto the mobile electronic device 502 through a direct, reliable and trusted connection to thereby provide secure device communication.

In some embodiments, the mobile electronic device 502 is provided with a service routing application programming interface (API) which provides an application with the ability to route traffic through a serial data (i.e., USB) or Bluetooth® connection to the host computer system using standard connectivity protocols. When a user connects their mobile electronic device 502 to the host computer system via a USB cable or Bluetooth®. connection, traffic that was destined for the wireless network 604 is automatically routed to the mobile electronic device 502 using the USB cable or Bluetooth® connection. Similarly, any traffic destined for the wireless network 604 is automatically sent over the USB cable Bluetooth® connection to the host computer system for processing.

The mobile electronic device 502 also includes a battery 638 as a power source, which is typically one or more rechargeable batteries that may be charged, for example, through charging circuitry coupled to a battery interface such as the serial data port 652. The battery 638 provides electrical power to at least some of the electrical circuitry in the mobile electronic device 502, and the battery interface 636 provides a mechanical and electrical connection for the battery 638. The battery interface 636 is coupled to a regulator (not shown) which provides power V+ to the circuitry of the mobile electronic device 502.

The short-range communication subsystem 662 is an additional optional component which provides for communication between the mobile electronic device 502 and different systems or devices, which need not necessarily be similar devices. For example, the subsystem 662 may include an infrared device and associated circuits and components, or a wireless bus protocol compliant communication mechanism such as a Bluetooth® communication module to provide for communication with similarly-enabled systems and devices (Bluetooth® is a registered trademark of Bluetooth SIG, Inc.).

A predetermined set of applications that control basic device operations, including data and possibly voice communication applications will normally be installed on the mobile electronic device 502 during or after manufacture. Additional applications and/or upgrades to the operating system 623 or software applications 625 may also be loaded onto the mobile electronic device 502 through the wireless network 604, the auxiliary I/O subsystem 650, the serial port 652, the short-range communication subsystem 662, or other suitable subsystem 664 other wireless communication interfaces. The downloaded programs or code modules may be permanently installed, for example, written into the program memory (i.e. the flash memory 644), or written into and executed from the RAM 646 for execution by the processor 640 at runtime. Such flexibility in application installation increases the functionality of the mobile electronic device 502 and may provide enhanced on-device functions, communication-related functions, or both. For example, secure communication applications may enable electronic commerce functions and other such financial transactions to be performed using the mobile electronic device 502.

The mobile electronic device 502 may include a personal information manager (PIM) application having the ability to organize and manage data items relating to a user such as, but not limited to, instant messaging, email, calendar events, voice mails, appointments, and task items. The PIM application has the ability to send and receive data items via the wireless network 604. In some example embodiments, PIM data items are seamlessly combined, synchronized, and updated via the wireless network 604, with the user's corresponding data items stored and/or associated with the user's host computer system, thereby creating a mirrored host computer with respect to these data items.

The mobile electronic device 502 may provide two principal modes of communication: a data communication mode and an optional voice communication mode. In the data communication mode, a received data signal such as a text message, an email message, or Web page download will be processed by the communication subsystem 611 and input to the processor 640 for further processing. For example, a downloaded Web page may be further processed by a browser application or an email message may be processed by an email message application and output to the display 642. A user of the mobile electronic device 502 may also compose data items, such as email messages, for example, using the touch-sensitive input surface 508 and/or navigation tool 570 in conjunction with the display device 642 and possibly the auxiliary I/O device 650. These composed items may be transmitted through the communication subsystem 611 over the wireless network 604.

In the voice communication mode, the mobile electronic device 502 provides telephony functions and operates as a typical cellular phone. The overall operation is similar, except that the received signals would be output to the speaker 656 and signals for transmission would be generated by a transducer such as the microphone 622. The telephony functions are provided by a combination of software/firmware (i.e., the voice communication module) and hardware (i.e., the microphone 622, the speaker 656 and input devices). Alternative voice or audio I/O subsystems, such as a voice message recording subsystem, may also be implemented on the mobile electronic device 502. Although voice or audio signal output is typically accomplished primarily through the speaker 656, the display device 642 may also be used to provide an indication of the identity of a calling party, duration of a voice call, or other voice call related information.

In addition to motion detection subsystem 649, which is used when the device 502 is in a keyboard mode, input verification mode, calibration mode or other modes utilizing input from a motion sensor, or in order to determine an emotional context of text entered into a messaging application run by the mobile device 502, other types of sensor detection subsystems 680 of FIG. 6 may be employed for determining an emotional context of text. As previously described, a large variety of sensors of sensor detection subsystem 680 may used to detect a current emotional state associated with text entered into a messaging application being executed by the mobile electronic device 502. The emotional state may be determined by a detected emotional state of a user of the mobile device, in which case the sensors may be biometric sensors of the type able to detect various physiological information about a user, such as blood pressure sensors, heart rate sensors, accelerometer sensors (which may capture shaking, tremors, or other movements, for example), video sensors operable to capture facial expressions of a user, and Galvanic skin response sensors. Biometric data collected by such biometric sensors may be considered to be autonomic and not within the purview of the user to control. The emotional state may also be determined by usage of the mobile electronic device and may further be under the direct control of the user. Sensors capable of capturing usage data include motion sensors or subsystems such as accelerometers and movement sensors, gyroscopes, tilt sensors, and magnetometers. It is understood that sensors used for collecting biometric or usage information may be used in any desired configuration, including single or in combination, and all such configurations are envisioned when referring to sensor detection subsystem 680.

Referring again to FIG. 6, motion detection subsystem 649 will now be described. The motion detection subsystem 649 comprises a motion sensor connected to the processor 640 which is controlled by one or a combination of a monitoring circuit and operating software. The motion sensor is typically an accelerometer. However, a sensor such as a strain gauge, pressure gauge, or piezoelectric sensor to detect motion may be used in other embodiments. Processor 640 may interact with an accelerometer to detect direction of gravitational forces or gravity-induced reaction forces.

As will be appreciated by persons skilled in the art, an accelerometer is a sensor which converts acceleration from motion (e.g. movement of the mobile electronic device 502 or a portion thereof due to the strike force) and gravity detected by a sensing element into an electrical signal (producing a corresponding change in output) and is available in one, two or three axis configurations. Accelerometers may produce digital or analog output signals. Thus, an accelerometer may interact with an accelerometer to detect direction of gravitational forces or gravity-induced reaction forces. Generally, two types of outputs are available depending on whether an analog or digital accelerometer used: (1) an analog output requiring buffering and analog-to-digital (A/D) conversion; and (2) a digital output which is typically available in an industry standard interface such as an SPI (Serial Peripheral Interface) or I2C (Inter-Integrated Circuit) interface.

The output of an accelerometer is typically measured in terms of the gravitational acceleration constant at the Earth's surface, denoted g, which is approximately 9.81 m/s.sup.2 (32.2 ft/s.sup.2) as the standard average. The accelerometer may be of almost any type including, but not limited to, a capacitive, piezoelectric, piezoresistive, or gas-based accelerometer. The range of accelerometers vary up to the thousands of g's, however for portable electronic devices “low-g” accelerometers may be used. Example low-g accelerometers which may be used are MEMS digital accelerometers from Analog Devices, Inc. (ADI), Freescale Semiconductor, Inc. (Freescale) and STMicroelectronics N.V. of Geneva, Switzerland. Example low-g MEMS accelerometers are model LIS331DL, LIS3021DL and LIS3344AL accelerometers from STMicroelectronics N.V. The LIS3344AL model is an analog accelerometer with an output data rate of up to 2 kHz which has been shown to have good response characteristics in analog sensor based motion detection subsystems.

The accelerometer is typically located in an area of the mobile electronic device 102 where the virtual keyboard is most likely to be displayed in at least some the keyboard modes. For example, the keyboard in a lower or central portion of the mobile electronic device 502. This allows improved sensitivities of the accelerometer when determining or verifying inputs on a virtual keyboard by positioning the accelerometer proximate to the location where the external force will likely be applied by the user. Each measurement axis of the accelerometer (e.g., 1, 2 or 3 axes) is typically aligned with an axis of the mobile electronic device 502. For example, for a 3-axis accelerometer the x-axis and y-axis may be aligned with a horizontal plane of the mobile electronic device 502 while the z-axis may be aligned with a vertical plane of the device 502. In such embodiments, when the device 502 is positioned horizontal (such as when resting on flat surface with the display screen 642 facing up) the x and y axes should measure approximately 0 g and the z-axis should measure approximately 1 g.

To improve the sensitivity of the accelerometer, its outputs can be calibrated to compensate for individual axis offsets and sensitivity variations. Calibrations can be performed at the system level to provide end-to-end calibration. Calibrations can also be performed by collecting a large set of measurements with the mobile electronic device 502 in different orientations.

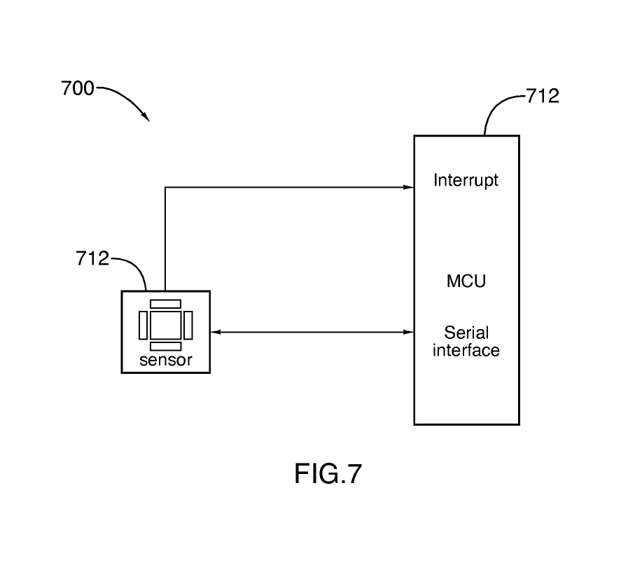

Referring briefly to FIG. 7, a motion detection subsystem 649 in accordance with one example embodiment of the present disclosure will be described. The circuit 700 comprises a digital 3-axis accelerometer 710 connected to the interrupt and serial interface of a controller (MCU) 712. The controller 712 could be the processor 640 of the device 502. The operation of the controller 712 is controlled by software, which may be stored in internal memory of the controller 712. The operational settings of the accelerometer 710 are controlled by the controller 712 using control signals sent from the controller 712 to the accelerometer 710 via the serial interface. The controller 712 may determine the motion detection in accordance with the acceleration measured by the accelerometer 710, or raw acceleration data measured by the accelerometer 710 may be sent to the processor 640 of the device 502 via its serial interface where motion detection is determined by the operating system 623, or other software module 621. In other embodiments, a different digital accelerometer configuration could be used, or a suitable analog accelerometer and control circuit could be used.

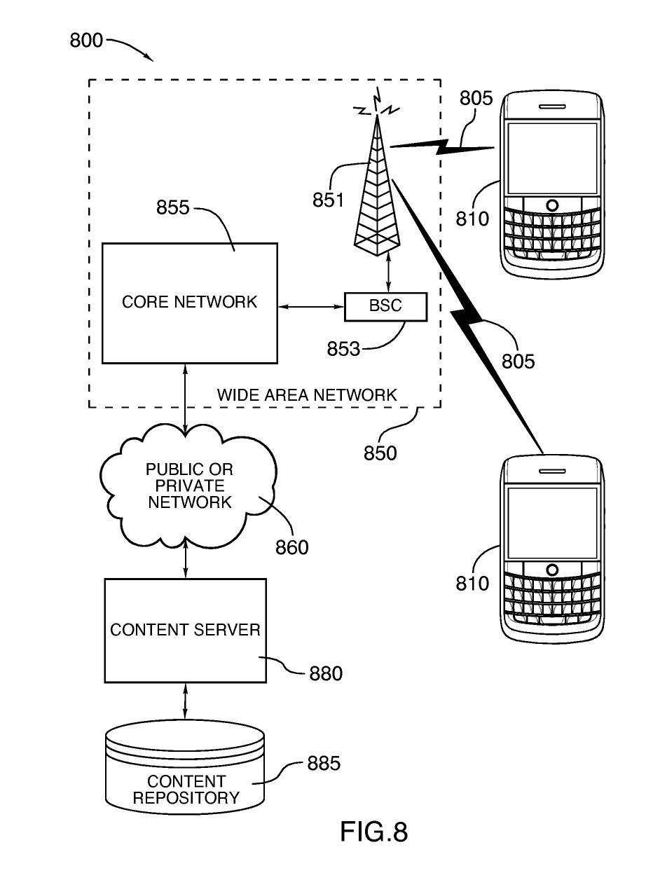

FIG. 8 is an illustration of an example network system 800 including first and second mobile electronic devices 810, in accordance with an example embodiment of the present disclosure. First and second mobile electronic devices 810 each have a wireless connection 805, such as a long-range wireless connection, with a wide area network 850. In this embodiment, the wide area network 850 comprises a plurality of base stations. For simplicity, only base station 851 is shown. Base station 851 is operatively connected to a base station controller 853, which in turn is connected to core network 855. Core network 855 is connected to network 860, which may be a public network such as the Internet, or a private corporate network. Mobile electronic devices 810 establish respective wireless connections 805 with base station 851 and accordingly have access to public network 860 and are able to exchange data with various entities connected to public network 860, such as content server 880.

Content server 880 provides access to devices 810 to content repository 885. Content repository 885 has electronic content stored thereon, the content being available for download by desktop computers, laptop computers, mobile electronic devices, and the like. Electronic content stored on content repository 885 includes electronic books, videos, music, photos, and the like. Clients may download content from the content repository 885 by making requests to content server 880 with an appropriate subscription, or for free if the downloaded content is in the public domain. Devices 810 may download electronic content from server 880 and content repository 885, over the wireless connection 805.

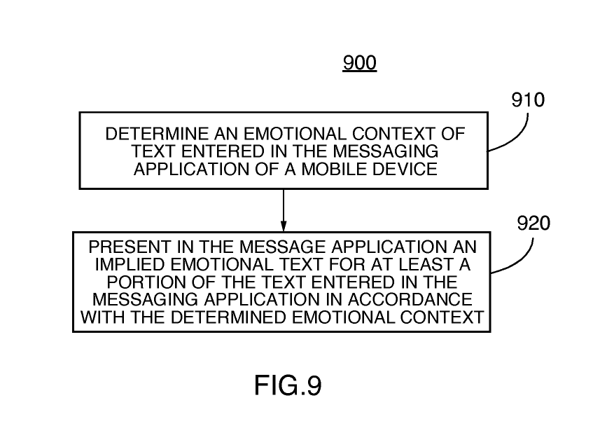

FIG. 9 is a flowchart illustrating a method 900 for conveying emotion in accordance with certain embodiments disclosed herein. At Block 910, an emotional context of text entered in the messaging application of a mobile device is determined. The text may be entered by a user in a text entry mode of the mobile device. The emotional context of the text may be determined while in the text entry mode of the mobile device, such as while the text is being entered, or after text has been entered, as might be the case when the device is no longer in the text entry mode.

As previously discussed, determining the emotional context of the text may be based upon captured biometric data or captured usage data from one or more sensors. In the exemplary embodiment of biometric data, biometric data about a user of the mobile device is captured and analyzed to determine the emotional context of the text. The biometric data may be captured about the user as the user enters text in a text entry mode of the mobile device if desired. The biometric data is captured by one or more biometric sensors, which may be include, singly or in any desired combination a blood pressure sensor, a heart rate sensor, an accelerometer sensor, a video sensor, and a Galvanic skin response sensor. The one or more biometric sensors may be located on the mobile electronic device or otherwise. For example, it can be envisioned that a video camera aimed on a user's face may collect biometric information about the user but not be located on the mobile device, but instead on a personal computer, or other communications device in communication with the mobile device. The biometric data may be captured in response to a trigger event, though this is not a requirement, particularly as the collection of, especially, biometric data may be ongoing and unknown (seamless) to the user. A trigger event for collection of biometric data may include entry of the mobile device into its text entry mode or detection of a user of the mobile device activating a navigation element of the mobile device to select a portion of entered text. A navigation element of the mobile device may be an optional joystick (OJ) of the mobile device, a trackball of the mobile device, or a touch-screen of the mobile device.

Alternately, the emotional context of the text may be determined from captured usage data that provides information about usage of the mobile device by a user. The captured usage data is analyzed to determine the emotional context of the text. The usage data is captured by one or more sensors, such as a gyroscope, an accelerometer or other motion sensor, a tilt sensor, a movement sensor, and a magnetometer. The usage data may be captured while in the text entry mode of the mobile device or in response to a trigger event, previously described.

In the example illustrated in FIG. 1A-1C, the usage data was motion data collected by one or more accelerometers while in the text entry mode of the mobile device. A user used a navigation element (the track ball) to select a portion of the entered text to be represented by implied emotional text.

At Block 920, an implied emotional text for at least a portion of the text entered in the messaging application is presented in accordance with the determined emotional context. The implied emotional text for the at least the portion of the text is different from a base text in which text is presented in the messaging application of the mobile device. This may occur, for example, when the determined emotional context of the text does not fall within a normal emotional range of text entered in the messaging application. It has been seen that at least a portion of the entered text may be selected to be presented as implied emotional text if desired and then presented. Or, as illustrated in FIG. 2, the entered text need not be selected and the implied emotional text in accordance with the determined emotional context is automatically presented in the display of the mobile device. For example, consider a mobile device having a touch-sensitive input surface of a touch screen display. The user may enter the text via the touch-sensitive input surface of the touch screen display of the mobile device while in a virtual keyboard mode of the mobile device, and the implied emotional text may be presented in the touch-sensitive input surface of the touch screen display of the mobile device. Alternately, presenting the implied emotional text may reference presenting the implied emotional text in a second display element of a second device in communication with the mobile device to which the implied emotional text has been transmitted and received.

The presented implied emotional text may have one or more components, including a font style component, an animation component, and a color component associated with the determined emotional context of the entered text. The implied emotional text is different from a base text in which text is normally presented in a text entry mode of the mobile device. The test entered may be presented as basic text prior to determining the emotional context of the entered text (reference FIG. 1A-1C) and as a function of the determined emotional context, transitioned from the basic text to an implied emotional text in accordance with the determined emotional context of the entered text. And one implied emotional text may be different from a previous emotional context of previous text entered. If the emotional context is different from the previous emotional context, the implied emotional text presented in accordance with the determined emotional context is different from a previous implied emotional text associated with the previous emotional context previously presented. The previous text may have been entered by a user while in a text entry mode of the mobile device.

The implied emotional text may be a user defined text, previously defined by the user and stored for retrieval by the processor when it is determined that it best represents the emotion gleaned from the sensor data.

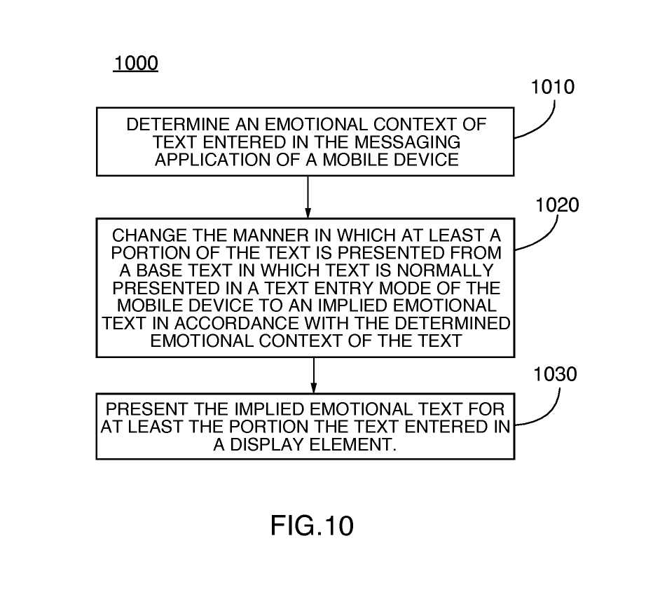

Reference is now made to flow 1000 of FIG. 10 in which an alternate method in accordance with various embodiments is illustrated. Whereas flow 900 of FIG. 9 simply illustrates presenting an implied emotional text in accordance with the determined emotional text, flow 1000 illustrates that the manner in which at least a portion of entered text is presented changes.

At Block 1010, an emotional context of text entered in the messaging application of a mobile device is determined. At Block 1020, the manner in which at least a portion of the text is presented is changed from a base text in which text is normally presented in a text entry mode of the mobile device to an implied emotional text in accordance with the determined emotional context of the text. This is clearly shown in FIGS. 1A-1C. At Block 1030, the implied emotional text for at least the portion of the text entered is presented in a display element. As discussed, this display element may be a display of the mobile electronic device or of another communications device, such as a remote mobile device with which the user of the mobile device is in communication via a quick messaging application.

As previously described, the emotional context of the entered text may be determined while in the text entry mode of the mobile device. If it is determined that the determined emotional context for the at least the portion of text is not within a normal emotional range, then the determined emotional context of the at least the portion of text is different from a previous emotional context of the entered text. The implied emotional text of the at least the portion of the text entered is accordingly presented as modified emotional text determined by the difference between the previous emotional context and the determined emotional context.

The implied emotional text may be presented in a touch-sensitive input surface of a touch screen display of the mobile device, previously described. The user may enter the text via the touch-sensitive input surface of the touch screen display of the mobile device while in a virtual keyboard mode of the mobile device.

Again, the implied emotional text for at least the portion may be displayed in a second display element of a second device in communication with the mobile device to which the implied emotional text is transmitted and received. The entered text may be presented as basic text prior to determining the emotional content of the entered text. Then, as a function of the determined emotional context, a transition from the basic text to presenting the implied emotional text in accordance with the determined emotional context of the entered text may occur.

Also, the entered text may continue to be presented as basic text if the determined emotional context is within a normal emotional range; this may be case, for example, where a user's biometric information indicates a little excitement but still within a normal range of emotion. Consider then, the method wherein determining the emotional context further comprises determining whether a current emotional state associated with the at least a portion of text entered in the messaging application of the mobile device is different from a previous emotional state of text entered in the messaging application; and presenting the at least the portion of text as modified text with an emotional context determined by the difference between the current emotional state and the previous emotional state when the difference between the current emotional state and the previous emotional state is not within a normal emotional range. The at least the portion of text may be presented as unmodified base text when a difference between the current emotional state and the previous emotional state is within the normal emotional range.

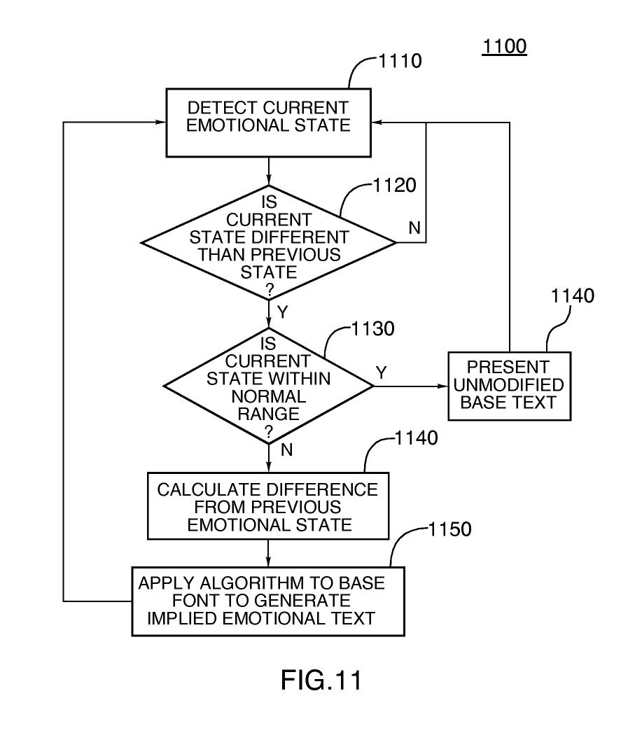

Flow 1100 of FIG. 11 illustrates the inquiry into whether the determined emotional state or context falls within a normal range. At Block 1110, the current emotional state associated with entered text is detected by one or more sensors. The inquiry at Decision Block 1120 is whether the current detected state is different from a previous state. If no, then the flow returns to Block 1110. If yes, then the inquiry at Block 1130 is whether the current state is within a normal range of emotion. If yes, then at Block 1140 the text is entered as unmodified base text. If no, then at Block 1150 the different from a previous emotional state is calculated and at Block 1160 an algorithm uses this determined difference to change the base font to a generated implied emotional text.

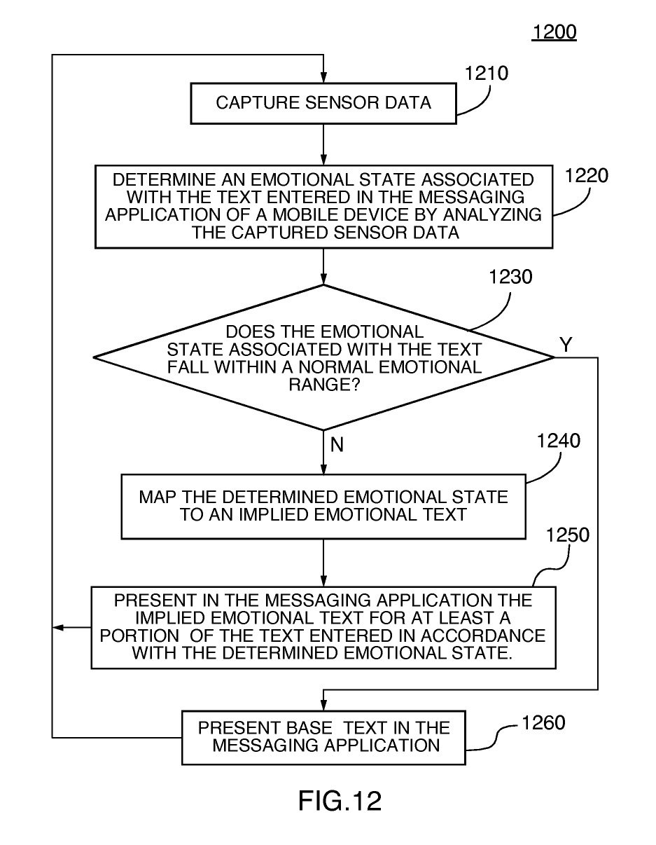

Referring now to FIG. 12, a flow 1200 that describes a method of conveying messaging application emotion in accordance with various embodiments is illustrated. AT Block 1210, sensor data is captured. The sensor data may be captured while in a text entry mode of the mobile device and the sensor data may be captured in the messaging application. Further, the text may be entered in the messaging application by a user of the mobile device, and may be during a text entry mode of the mobile device.

As described, the sensor data may be biometric data captured by one or more biometric sensors. While it is envisioned that the biometric sensors, which may be a blood pressure sensor, a heart rate sensor, an accelerometer sensor, a video sensor, a Galvanic skin response sensor, etc. are part of the mobile device, such is not required. For example, a video sensor may be of the mobile device but need not be in order to capture biometric facial expressions of a user of the mobile device. The sensor data may be usage data about usage of the mobile device by a user and may be provided by sensors such as a gyroscope, an accelerometer or other motion sensor, a tilt sensor, a movement sensor, and a magnetometer. As before, the sensors may capture sensor data in response to some trigger event.

An emotional state associated with entered text is determined by analyzing the captured sensor data at Block 1220. This may be determined while in a text entry mode of the mobile device, but is not required. An algorithm of the processor determines the emotional state by analyzing the captured sensor data. The inquiry at Block 1230 is whether the determined emotional state falls within a normal emotional range. If yes, then the text is presented as base text in the messaging application at Block 1260. If no, then at Block 1240, the determined emotional state is mapped by the algorithm to an implied emotional text. This mapping including calculating the difference between the determined emotional state and using the degree of emotion indicated by the difference to generate the implied emotional text. A greater determined difference between the determined emotional state and a base text will yield an implied emotional text showing more emotion. Sensor data indicating an ecstatic user will have a more exaggerated implied emotional text than sensor data merely indicative of minor happiness. The implied emotional text is presented in the messaging application at Block 1250 for at least a portion of the entered text.

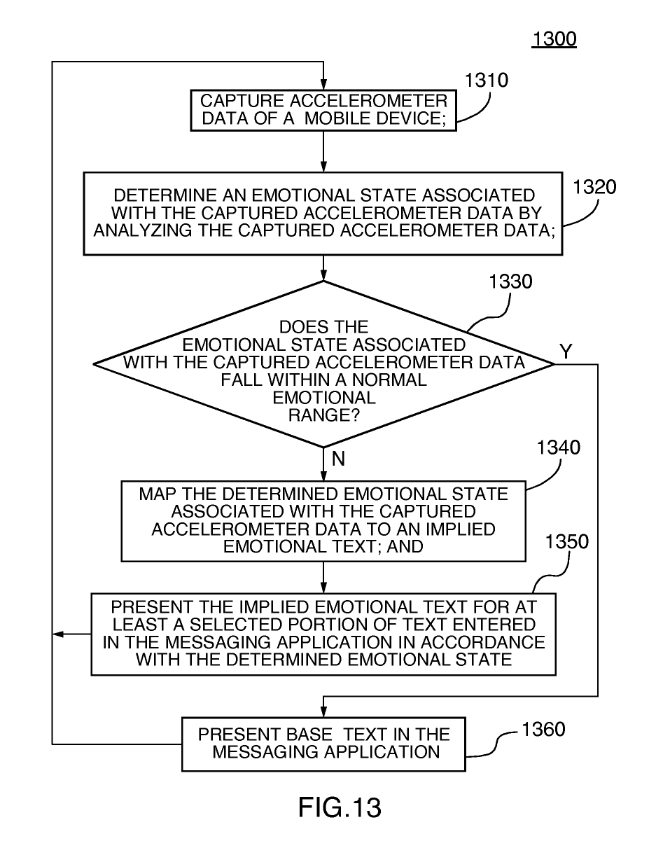

Flow 1300 of FIG. 13 illustrates the use of accelerometer data collected by one or more accelerometers of a mobile device. Please note that the accelerometer data may be either biometric data or usage data, as it is envisioned that an accelerometer detection element may be used to capture biometric or usage information. At Block 1310, accelerometer data of a mobile device is captured by one or more accelerometer elements. This may be accomplished by a user typing something into a quick messaging application and then holding down the track ball or optional joystick (trackpad) to capture accelerometer data. At Block 1320, an emotional state associated with the captured accelerometer data is determined by analyzing the captured accelerometer data. The inquiry at Block 1330 is whether the emotional state associated with the captured accelerometer data falls within a normal emotional range. If yes, indicating that base text should be displayed, the flow continues to Block 1360.

If, however, the emotional state is not normal, at Block 1340 the determined emotional state associated with the captured accelerometer data is mapped to an implied emotional text as described. This may be accomplished, for example, by taking accelerometer data from a small sample to choose a font style and animation. The animation could be a mapping of the accelerometer data or it could be picking the closest match to certain parameters of an algorithm to choose a previously defined animation pattern. Thus, a font and animation may be mapped to the text based on an algorithm that analyzes aspects of the accelerometer data. Harsh and rapid transitions might be represented by a more frantic looking font with an animation character that may be harsh and rapid. A slower acceleration pattern may be represented at a slower animation pace in a soft, comfortable font. The direction of the accelerometer movements might affect the animation, with a forward and backward movement making the font pulse (shrinking and growing), where side-to-side movements might make the font wave or vibrate or cause a wave or vibration to travel through the text. As described, the implied emotional text may have a color component as well, with red being mapped for detected rapid, harsh movements.

The implied emotional text for at least a selected portion of text entered in the messaging application is presented at Block 1350 in accordance with the determined emotional state.

While the blocks comprising the methods are shown as occurring in a particular order, it will be appreciated by those skilled in the art that many of the blocks are interchangeable and can occur in different orders than that shown without materially affecting the end results of the methods.

The implementations of the present disclosure described above are intended to be examples only. Those of skill in the art can effect alterations, modifications and variations to the particular example embodiments herein without departing from the intended scope of the present disclosure. Moreover, selected features from one or more of the above-described example embodiments can be combined to create alternative example embodiments not explicitly described herein.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A method of conveying emotion in a messaging application, comprising:
determining an emotional context of text entered in the messaging application of a mobile device;
changing the manner in which at least a portion of the text is presented from a base text in which text is normally presented in a text entry mode of the mobile device to an implied emotional text in accordance with the determined emotional context of the text; and
presenting the implied emotional text for at least the portion of the text entered in a display element.

2. The method of claim 1, further comprising determining the emotional context of text entered while in the text entry mode of the mobile device

3. The method of claim 1, further comprising:
determining that the determined emotional context of the at least the portion of text is different from a previous emotional context of the entered text; and
presenting the implied emotional text of the at least the portion of the text entered as modified emotional text determined by the difference between the previous emotional context and the determined emotional context.

4. The method of claim 1, wherein presenting further comprises presenting the implied emotional text in a touch-sensitive input surface of a touch screen display of the mobile device.

5. The method of claim 1, wherein presenting further comprises presenting the implied emotional text for at least the portion in a second display element of a second device in communication with the mobile device to which the implied emotional text is transmitted and received.

6. The method of claim 1, further comprising:
presenting the text entered as basic text prior to determining the emotional context of the entered text; and
as a function of the determined emotional context, transitioning from presenting the basic text to presenting the implied emotional text in accordance with the determined emotional context of the entered text

7. The method of claim 1, wherein determining the emotional context further comprises:
determining whether a current emotional state associated with the at least a portion of text entered in the messaging application of the mobile device is different from a previous emotional state of text entered in the messaging application; and
presenting the at least the portion of text as modified text with an emotional context determined by the difference between the current emotional state and the previous emotional state when the difference between the current emotional state and the previous emotional state is not within a normal emotional range.

8. The method of claim 7, further comprising:
presenting the at least the portion of text as unmodified base text when a difference between the current emotional state and the previous emotional state is within the normal emotional range.

9. A computer-readable medium having computer-readable code executable by at least one processor of the portable electronic device to perform the method of claim 1.

10. A method of conveying emotion in a messaging application, comprising:
determining an emotional context of text entered in the messaging application of a mobile device; and
presenting in the messaging application an implied emotional text for at least a portion of the text entered in the messaging application in accordance with the determined emotional context, wherein the implied emotional text for the at least the portion of the text is different from a base text in which text is presented in the messaging application of the mobile device.

11. The method of claim 10, further comprising:
selecting the at least the portion of the text entered to convey emotion in the messaging application; and
presenting the implied emotional text for the selected at least the portion of the text.

12. The method of claim 10, wherein determining the emotional context of the text comprises capturing and analyzing one or more of biometric data about a user of the mobile device and usage data about usage of the mobile device by the user to determine the emotional context of the text.

13. The method of claim 10, wherein presenting further comprises presenting the implied emotional text in a display element of the mobile device.

14. The method of claim 13, further comprising presenting the implied emotional text in a touch-sensitive input surface of a touch screen display of the mobile device.

15. The method of claim 10, wherein presenting further comprises presenting the implied emotional text in a second display element of a second device in communication with the mobile device to which the implied emotional text is transmitted and received.

16. The method of claim 10, further comprising:
determining whether the emotional context of the text is different from a previous emotional context of previous text entered; and
if the emotional context is different from the previous emotional context, the implied emotional text presented in accordance with the determined emotional context is different from a previous implied emotional text associated with the previous emotional context previously presented.

17. The method of claim 10, further comprising:
a user entering the text via a touch-sensitive input surface of a touch screen display of the mobile device while in a virtual keyboard mode of the mobile device; and
presenting the implied emotional text in the touch-sensitive input surface of the touch screen display of the mobile device.

18. The method of claim 10, further comprising:
presenting the text entered as basic text prior to determining the emotional context of the entered text;
as a function of the determined emotional context, transitioning from presenting the basic text to presenting the implied emotional text in accordance with the determined emotional context of the entered text.

19. A computer-readable medium having computer-readable code executable by at least one processor of the portable electronic device to perform the method of claim 10.

20. A mobile device, comprising:
a processor for controlling operation of the mobile device; and
a sensor detection element coupled to the processor and configured to capture data representative of an emotional context of text entered in a messaging application of the mobile device;
the processor being configured to determine the emotional context from the captured data and to change the manner in which at least a portion of the text is normally presented in a text entry mode of the mobile device to an implied emotional text in accordance with the determined emotional context of the text.

21. The mobile device of claim 20, wherein the processor controls the sensor detection element to capture data representative of the emotional context in response to a trigger event.

22. The mobile device of claim 20, wherein the sensor detection element comprises one or more of one or more biometric sensors configured to capture biometric data of a user of the mobile device and one or more sensors configured to capture usage data of usage of the mobile device by the user.

23. The mobile device of claim 20, the device further comprising a user interface coupled to and controlled by the processor that is configured to permit user interaction with the mobile device, wherein a user selects the at least the portion of the text to be presented by the determined emotional text is selected and received by the mobile device via the user interface.

24. The mobile device of claim 20, the mobile device further comprising a display element, wherein the processor is further configured to determine whether a current emotional state associated with the at least a portion of text entered in the messaging application of the mobile device is different from a previous emotional state of text entered in the messaging application and to present the at least the portion of text in the display element as modified text with an emotional context determined by the difference between the current emotional state and the previous emotional state when the difference between the current emotional state and the previous emotional state is not within a normal emotional range.

25. The mobile device of claim 20, wherein the presented implied emotional text comprises one or more of a font style component, an animation component, and a color component associated with the determined emotional context of the entered text.

26. The mobile device of claim 20, the device further comprising a touch screen display with a touch-sensitive input surface and the processor is configured to control the touch screen display to display the implied emotional text in the touch-sensitive input surface of the touch screen display.
